(19) United States
(12) Patent Application Publication
(10) Pub. No.: US 2024/0034430 A1
(43) Pub. Date: Feb. 1, 2024

(54) CONTROL DEVICE FOR HUMAN-POWERED VEHICLE

(71) Applicant: Shimano Inc., Osaka (JP)

(72) Inventors: Satoshi SHAHANA, Osaka (JP); Tadaharu KUROTOBI, Osaka (JP)

(21) Appl. No.: 18/220,511

(22) Filed: Jul. 11, 2023

(30) Foreign Application Priority Data
Jul. 28, 2022 (JP) 2022-120149

(51) Int. Cl. B62M 6/45; B62M 25/08

(52) U.S. Cl. CPC B62M 6/45; B62M 25/08

(57) ABSTRACT

A control device for a human-powered vehicle includes an electronic controller. The human-powered vehicle includes a crank axle configured to receive a human driving force, a first rotational body connected to the crank axle, a wheel, a second rotational body connected to the wheel, a transmission body engaged with the first rotational body and the second rotational body to transmit the driving force between the first rotational body and the second rotational body, a motor configured to drive the transmission body, and a first operating unit configured to be operable by a user of the human-powered vehicle and irrelevant to a shifting operation of the human-powered vehicle. The electronic controller is configured to control the motor so as to drive the transmission body with the motor without propelling the human-powered vehicle with the driving force of the motor upon the user operating the first operating unit.

### CROSS-REFERENCE TO RELATED APPLICATIONS

This application claims priority to Japanese Patent Application No. 2022-120149, filed on Jul. 28, 2022. The entire disclosure of Japanese Patent Application No. 2022-120149 is hereby incorporated herein by reference.

### BACKGROUND

### Technical Field

The present disclosure generally relates to a control device for a human-powered vehicle.

### Background Information

One example of a control device for a human-powered vehicle is disclosed in Japanese Patent No. 5686876. In this Japanese patent, the control device is configured to control a motor configured to drive a transmission body.

### SUMMARY

An objective of the present disclosure is to provide a control device for a human-powered vehicle that controls a motor in a preferred manner.

A control device in accordance with a first aspect of the present disclosure is for a human-powered vehicle. The human-powered vehicle includes a crank axle, a first rotational body, a wheel, a second rotational body, a transmission body, a motor, and a first operating unit. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The motor is configured to drive the transmission body. The first operating unit is configured to be operable by a user of the human-powered vehicle and irrelevant to a shifting operation of the human-powered vehicle. The control device comprises an electronic controller configured to control the motor so as to drive the transmission body with the motor without propelling the human-powered vehicle with the driving force of the motor upon the user operating the first operating unit. The control device according to the first aspect drives the motor without propelling the human-powered vehicle with the driving force of the motor upon the user operating the first operating unit. Thus, the electronic controller controls the motor in a preferred manner as intended by the user.

In accordance with a second aspect of the present disclosure, the control device according to the first aspect is configured so that the electronic controller is configured to drive the transmission body with the motor without propelling the human-powered vehicle with the driving force of the motor upon the user operating the first operating unit in a case where a first condition is satisfied. The first condition includes a condition in which rotation of the crank axle is stopped. The control device according to the second aspect controls the motor without propelling the human-powered vehicle with the driving force of the motor upon the user operating the first operating unit in a case where rotation of the crank axle is stopped.

In accordance with a third aspect of the present disclosure, the control device according to the first or second aspect is configured so that the electronic controller is configured to stop the motor in a case where the user stops operating the first operating unit. The control device according to the third aspect stops the motor in a case where the user stops operating the first operating unit, and thereby allowing the user to easily stop the motor. Thus, the control device improves usability.

In accordance with a fourth aspect of the present disclosure, the control device according to any one of the first to third aspects is configured so that in a case where the user operates the first operating unit to drive the motor and then stops operating the first operating unit, the electronic controller is configured to stop the motor upon the user operating the first operating unit again. With the control device according to the fourth aspect, in a case where the user operates the first operating unit to drive the motor and then stops operating the first operating unit, the control device stops the motor upon the user operating the first operating unit again. This allows the user to easily stop the motor. Thus, the control device improves usability.

In accordance with a fifth aspect of the present disclosure, the control device according to any one of the first to fourth aspects is configured so that the human-powered vehicle further includes a second operating unit that differs from the first operating unit. The second operating unit is configured to be operable by the user. In a case where the user operates the first operating unit and drives the motor, the electronic controller is configured to stop the motor upon the user operating the second operating unit. With the control device according to the fifth aspect, in a case where the user operates the first operating unit and drives the motor, the control device stops the motor upon the user operating the second operating unit. This allows the user to easily stop the motor. Thus, the control device improves usability.

In accordance with a sixth aspect of the present disclosure, the control device according to any one of the first to fifth aspects is configured so that in a case where the user operates the first operating unit and drives the motor, the electronic controller is configured to stop the motor upon a stopping condition of the motor being satisfied. The stopping condition includes at least one of a first stopping condition in which a predetermined period elapses from when driving of the motor is started and a second stopping condition in which a load on the motor is greater than or equal to a first threshold value. With the control device according to the sixth aspect, as the user operates the first operating unit and drives the motor, the control device stops the motor in at least one of a case where the predetermined period elapses from when driving the motor is started and a case where the load on the motor is greater than or equal to the first threshold value. Thus, the control device drives the motor in a preferred manner.

In accordance with a seventh aspect of the present disclosure, the control device according to the second aspect is configured so that the electronic controller is configured to drive the transmission body with the motor to propel the human-powered vehicle with the driving force of the motor upon the user operating the first operating unit in a case where the first condition and a second condition are satisfied. The second condition includes a condition in which a speed of the human-powered vehicle is less than a predetermined speed. The control device according to the seventh aspect drives the motor to propel the human-powered vehicle with the driving force of the motor upon the user operating the first operating unit in a case where rotation of the crank axle is stopped and the vehicle speed is less than the predetermined speed.

In accordance with an eighth aspect of the present disclosure, the control device according to the second or seventh aspect is configured so that the electronic controller is configured to control a derailleur that is configured to operate the transmission body and shift a transmission ratio of a rotational speed of the wheel to a rotational speed of the crank axle. The electronic controller is configured to drive the transmission body with the motor and operate the transmission body with the derailleur in a case where the first condition and a shifting condition for shifting the transmission ratio with the derailleur are satisfied. The control device according to the eighth aspect controls the motor so as to drive the transmission body with the motor in a case where rotation of the crank axle is stopped and the shifting condition is satisfied. This allows the derailleur to change the transmission ratio in a preferred manner.

A control device in accordance with a ninth aspect of the present disclosure is for a human-powered vehicle. The human-powered vehicle includes a crank axle, a first rotational body, a wheel, a second rotational body, a transmission body, and a motor. The crank axle is configured to receive a human driving force. The first rotational body is connected to the crank axle. The second rotational body is connected to the wheel. The transmission body is engaged with the first rotational body and the second rotational body to transmit a driving force between the first rotational body and the second rotational body. The motor is configured to drive the transmission body. The control device comprises an electronic controller configured to control the motor so as to drive the transmission body with the motor without propelling the human-powered vehicle with the driving force of the motor in a case where a third condition is satisfied. The third condition includes a condition related to at least one of an inclination of the human-powered vehicle and a load on the human-powered vehicle. The control device according to the ninth aspect drives the motor without propelling the human-powered vehicle with the driving force of the motor in a case where the condition related to at least one of the inclination of the human-powered vehicle and the load on the human-powered vehicle is satisfied.

In accordance with a tenth aspect of the present disclosure, the control device according to the ninth aspect is configured so that the third condition includes at least one of a condition in which the human-powered vehicle is traveling on a road corresponding to a downhill having a predetermined gradient or greater and a condition in which a pitch angle of the human-powered vehicle is less than or equal to a predetermined angle that is less than zero. The control device according to the tenth aspect drives the motor without propelling the human-powered vehicle with the driving force of the motor in a case where at least one of the condition in which the human-powered vehicle is traveling on a road corresponding to a downhill having the predetermined gradient or greater and the condition in which the pitch angle of the human-powered vehicle is less than or equal to the predetermined angle that is less than zero is satisfied.

In accordance with an eleventh aspect of the present disclosure, the control device according to the ninth or tenth aspect is configured so that in a case where the third condition is satisfied and the motor is driven, the electronic controller is configured to stop the motor upon a stopping condition of the motor being satisfied. The stopping condition includes at least one of a first stopping condition in which a predetermined period elapses from when driving of the motor is started and a second stopping condition in which a load on the motor is greater than or equal to a first threshold value. With the control device according to the eleventh aspect, in a case where the third condition is satisfied and the motor is driven, the control device stops the motor in at least one of a case where the predetermined period elapses from when driving of the motor is started and a case where the load on the motor is greater than or equal to the first threshold value.

In accordance with a twelfth aspect of the present disclosure, the control device according to any one of the ninth to eleventh aspects is configured so that the third condition further includes a condition in which rotation of the crank axle is stopped. The control device according to the twelfth aspect drives the motor without propelling the human-powered vehicle with the driving force of the motor in a case where the condition related to at least one of the inclination of the human-powered vehicle and the load on the human-powered vehicle is satisfied and the condition in which rotation of the crank axle is stopped is satisfied. In accordance with a thirteenth aspect of the present disclosure, the control device according to any one of the ninth to twelfth aspects is configured so that the human-powered vehicle further includes a derailleur configured to operate the transmission body and shift a transmission ratio of a rotational speed of the wheel to a rotational speed of the crank axle. The third condition further includes a condition in which the derailleur is deactivated. The control device according to the thirteenth aspect drives the motor without propelling the human-powered vehicle with the driving force of the motor in a case where the condition related to at least one of the inclination of the human-powered vehicle and the load on the human-powered vehicle is satisfied, the condition in which rotation of the crank axle is stopped is satisfied, and the condition in which the derailleur is deactivated is satisfied.

In accordance with a fourteenth aspect of the present disclosure, the control device according to the thirteenth aspect is configured so that the electronic controller is configured to control the derailleur. The electronic controller is configured to drive the transmission body with the motor and operate the transmission body with the derailleur in a case where a first condition and a shifting condition for shifting the transmission ratio with the derailleur are satisfied. The first condition includes a condition in which rotation of the crank axle is stopped. The control device according to the fourteenth aspect controls the motor so as to drive the transmission body with the motor in a case where rotation of the crank axle is stopped and the shifting condition is satisfied. This allows the derailleur to change the transmission ratio in a preferred manner.

In accordance with a fifteenth aspect of the present disclosure, the control device according to the sixth or eleventh aspect is configured so that the predetermined period includes at least one of a predetermined time, a period during which an output shaft of the motor is rotated more than a first rotational angle, and a period during which the first rotational body is rotated by the motor more than a second rotational angle. The control device according to the fifteenth aspect stops the motor in a case where at least one of the predetermined time, the period during which the output shaft of the motor is rotated more than the first rotational angle, and the period during which the first rotational body is rotated by the motor more than the second rotational angle elapses from when driving of the motor is started.

In accordance with a sixteenth aspect of the present disclosure, the control device according to the eighth or fourteenth aspect is configured so that the shifting condition is related to at least one of a traveling state of the human-powered vehicle, a traveling environment of the human-powered vehicle, and an operating state of a shifting device of the human-powered vehicle. The control device according to the sixteenth aspect controls the motor so as to drive the transmission body with the motor in a case where rotation of the motor is stopped as the condition related to at least one of the traveling state, the traveling environment, and the operating state of the human-powered vehicle is satisfied. This allows the derailleur to change the transmission ratio in a preferred manner.

The control device for the human-powered vehicle of the present disclosure controls the motor in a preferred manner.

### BRIEF DESCRIPTION OF THE DRAWINGS

Referring now to the attached drawings which form a part of this original disclosure.

FIG. 1 is a side elevational view of a human-powered vehicle including a human-powered vehicle control device in accordance with an embodiment.

FIG. 2 is a block diagram showing the electrical configuration of the human-powered vehicle shown in FIG. 1.

FIG. 3 is a cross-sectional view of a drive unit for the human-powered vehicle shown in FIG. 1.

FIG. 4 is a flowchart illustrating a control process executed by an electronic controller shown in FIG. 2 to control a motor.

FIG. 5 is a block diagram showing the electrical configuration of a human-powered vehicle including a human-powered vehicle control device in accordance with a second embodiment.

FIG. 6 is a flowchart illustrating a first part of a control process executed by an electronic controller shown in FIG. 5 to control a motor and a derailleur.

FIG. 7 is a flowchart illustrating a second part of the control process executed by the electronic controller shown in FIG. 5 to control the motor and the derailleur.

FIG. 8 is a block diagram showing the electrical configuration of a human-powered vehicle including a control device in accordance with a third embodiment.

FIG. 9 is a flowchart illustrating a control process executed by an electronic controller shown in FIG. 8 to control a motor and a derailleur.

FIG. 10 is a flowchart illustrating a control process executed by an electronic controller of a first modification to control a motor.

FIG. 11 is a block diagram showing the electrical configuration of a human-powered vehicle including a control device of a second modification.

FIG. 12 is a flowchart illustrating a control process executed by an electronic controller of the second modification to control a motor.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### First Embodiment

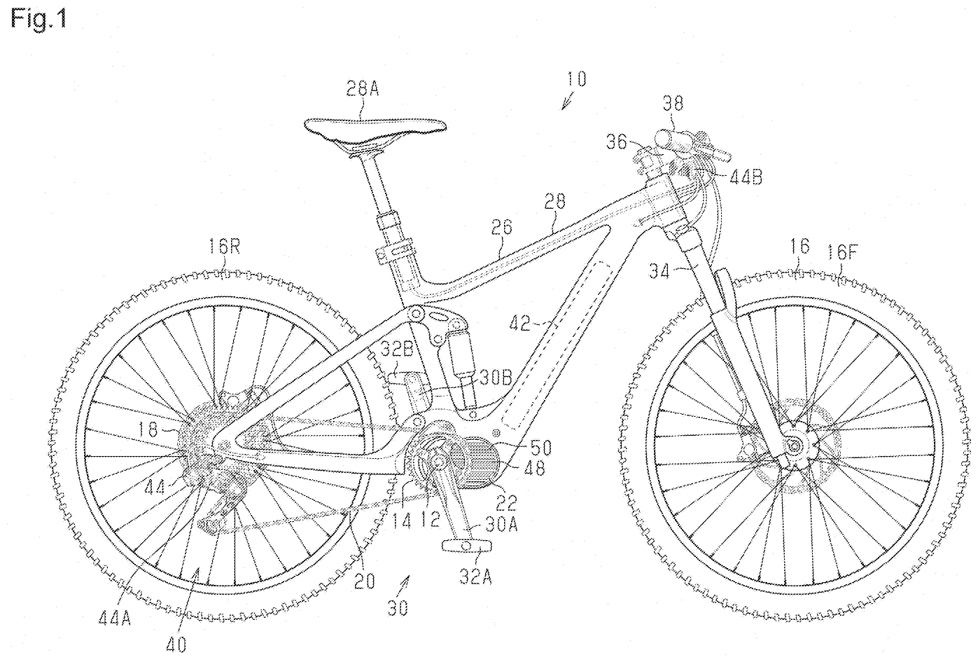

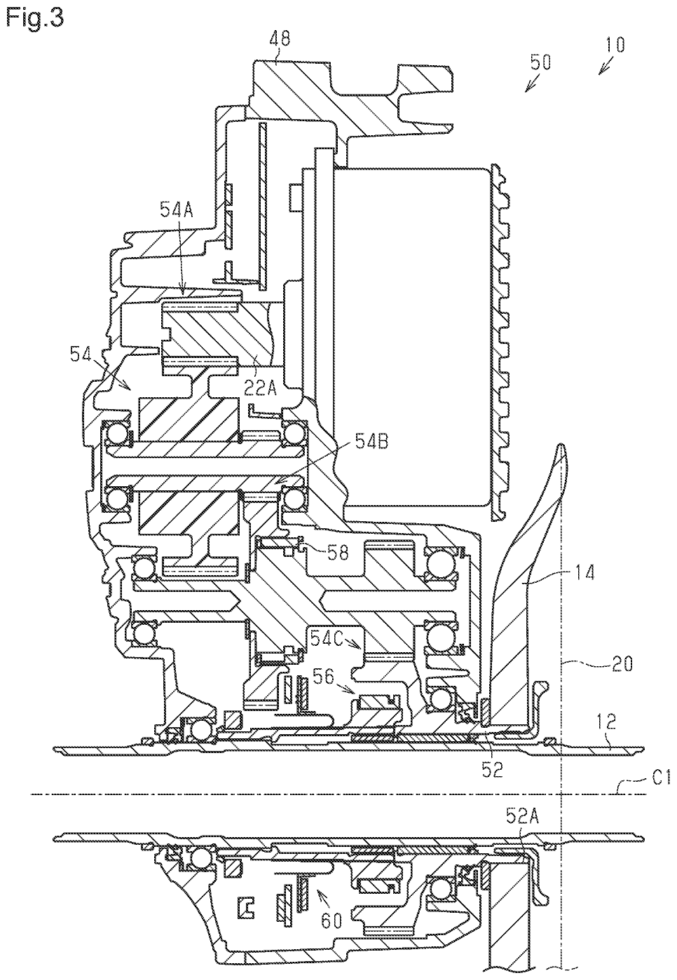

A control device 70 for a human-powered vehicle will now be described with reference to FIGS. 1 to 4. A human-powered vehicle is a vehicle that includes at least one wheel and can be driven by at least a human driving force. Examples of the human-powered vehicle include various types of bicycles such as a mountain bike, a road bike, a city bike, a cargo bike, a handcycle, and a recumbent bike. There is no limit to the number of wheels of the human-powered vehicle. The human-powered vehicle also includes, for example, a unicycle or a vehicle having two or more wheels. The human-powered vehicle is not limited to a vehicle that can be driven only by a human driving force. The human-powered vehicle includes an electric bicycle (E-bike) that uses drive force of an electric motor for propulsion in addition to the human driving force. The E-bike includes an electric assist bicycle that assists in propulsion with an electric motor. In each embodiment described hereafter, the human-powered vehicle will be described as a bicycle.

A human-powered vehicle 10 includes a crank axle 12, a first rotational body 14, a wheel 16, a second rotational body 18, a transmission body 20, a motor 22, and a first operating unit 24. The crank axle 12 is configured to receive a human driving force. The first rotational body 14 is connected to the crank axle 12. The second rotational body 18 is connected to the wheel 16. The transmission body 20 is engaged with the first rotational body 14 and the second rotational body 18 to transmit a driving force between the first rotational body 14 and the second rotational body 18.

The human-powered vehicle 10 further includes, for example, a vehicle body 26. The vehicle body 26 includes, for example, a frame 28. A saddle 28A is provided on the frame 28. The wheel 16 includes, for example, a front wheel 16F and a rear wheel 16R. The crank axle 12 is, for example, rotatable relative to the frame 28. The human-powered vehicle 10 includes, for example, a crank 30. The crank 30 includes the crank axle 12 and crank arms 30A and 30B.

The crank arm 30A is, for example, provided on a first axial end of the crank axle 12, and the crank arm 30B is provided on a second axial end of the crank axle 12. The human-powered vehicle 10 includes, for example, a pair of pedals 32A and 32B. The pedal 32A is, for example, coupled to the crank arm 30A. The pedal 32B is, for example, coupled to the crank arm 30B. The rear wheel 16R is, for example, driven by rotation of the crank axle 12. The rear wheel 16R is, for example, supported by the frame 28. The front wheel 16F is attached to the frame 28 by a front fork 34. A handlebar 38 is coupled to the front fork 34 by a stem 36.

The human-powered vehicle 10 further includes, for example, a drive mechanism 40. For example, the drive mechanism 40 connects at least one of the front wheel 16F and the rear wheel 16R to the crank 30. In the present embodiment, the drive mechanism 40 connects the rear wheel 16R to the crank 30.

The drive mechanism 40 includes, for example, the first rotational body 14, the second rotational body 18, and the transmission body 20. The first rotational body 14 is connected to the crank axle 12. The second rotational body 18 is connected to the wheel 16. The transmission body 20 is engaged with the first rotational body 14 and the second rotational body 18 to transmit the driving force between the first rotational body 14 and the second rotational body 18. The transmission body 20 transmits, for example, rotational force of the first rotational body 14 to the second rotational body 18.

The first rotational body 14 is, for example, arranged coaxially with the crank axle 12. The first rotational body 14 does not have to be arranged coaxially with the crank axle 12. In a case where the first rotational body 14 is not arranged coaxially with the crank axle 12, the first rotational body 14 is, for example, connected to the crank axle 12 by a first transmission mechanism. The first transmission mechanism can include a set of gears, a set of sprockets and a chain, a set of pulleys and a belt, or a set of shafts and bevel gears. The first rotational body 14 includes, for example, at least one first sprocket or at least one first pulley.

The second rotational body 18 is, for example, arranged coaxially with the rear wheel 16R. The second rotational body 18 does not have to be arranged coaxially with the rear wheel 16R. In a case where the second rotational body 18 is not arranged coaxially with the rear wheel 16R, the second rotational body 18 is, for example, connected to the rear wheel 16R by a second transmission mechanism. The second transmission mechanism can include a set of gears, a set of sprockets and a chain, a set of pulleys and a belt, or a set of shafts and bevel gears. The second rotational body 18 includes, for example, at least one second sprocket or at least one second pulley.

The second rotational body 18 is, for example, connected to the rear wheel 16R by a first one-way clutch. The first one-way clutch includes, for example, at least one of a roller clutch, a sprag clutch, and a ratchet clutch. The first one-way clutch is configured to transmit the driving force from the second rotational body 18 to the rear wheel 16R in a case where the second rotational body 18 is rotated in accordance with a forward rotation of the first rotational body 14. Further, the first one-way clutch is configured to allow relative rotation of the rear wheel 16R and the second rotational body 18 in a case where the speed at which the rear wheel 16R is rotated forward is higher than the speed at which the second rotational body 18 is rotated forward.

The human-powered vehicle 10 further includes, for example, a battery 42. The battery 42 includes one or more battery cells. Each battery cell includes a rechargeable battery. The battery 42 is, for example, configured to supply electric power to the control device 70 and the motor 22. The battery 42 is, for example, connected to the control device 70 in a manner allowing for wired communication or wireless communication. The battery 42 is configured to establish communication with the control device 70 through, for example, power line communication (PLC), Controller Area Network (CAN), or universal asynchronous receiver/transmitter (UART).

The human-powered vehicle 10 can further include, for example, a transmission device 44. The transmission device 44 is, for example, provided in a transmission path of a human driving force in the human-powered vehicle 10 and is configured to shift a transmission ratio. The transmission ratio is, for example, a ratio of a rotational speed of the wheel 16 to a rotational speed of the crank 30. The rotational speed of the wheel 16 includes, for example, the rotational speed of the drive wheel. The transmission device 44 includes, for example, at least one of a derailleur 44A and an internal transmission device. In a case where the transmission device 44 includes an internal transmission device, the internal transmission device is, for example, provided in a hub of the rear wheel 16R. The internal transmission device includes a continuously variable transmission (CVT). An electronic controller 72 can be configured to control the transmission device 44.

In the present embodiment, the transmission device 44 includes the derailleur 44A. The derailleur 44A is configured to operate the transmission body 20 and shift the transmission ratio of the rotational speed of the wheel 16 to a rotational speed of the crank axle 12. The derailleur 44A includes, for example, at least one of a front derailleur and a rear derailleur. In a case where the derailleur 44A includes at least one of a front derailleur and a rear derailleur, the transmission body 20 includes a chain. The transmission body 20 can include a belt.

The derailleur 44A moves, for example, the transmission body 20 from a position engaged with one of sprockets to a position engaged with another one of the sprockets.

The derailleur 44A is, for example, configured to operate the transmission body 20 and shift the transmission ratio of the rotational speed of the wheel 16 to the rotational speed of the crank axle 12. The derailleur 44A is, for example, provided in the transmission path of the human driving force in the human-powered vehicle 10, and is configured to shift the transmission ratio. The derailleur 44A shifts the transmission ratio by, for example, operating the transmission body 20 and changing the engagement state of the transmission body 20 and at least one of the first rotational body 14 and the second rotational body 18. The relationship of the transmission ratio, the rotational speed of the wheel 16, and the rotational speed of the crank axle 12 satisfies the following equation (1). In equation (1), the term “R” represents the transmission ratio. In equation (1), the term “W” represents the rotational speed of the wheel 16. In equation (1), the term “C” represents the rotational speed of the crank axle 12.

R=W (rpm)/C (rpm) Equation (1):

The derailleur 44A can shift the transmission ratio in accordance with, for example, at least one transmission stage. The derailleur 44A is, for example, configured to operate the transmission body 20 and shift the at least one transmission stage. The at least one transmission stage is, for example, set in accordance with at least one of the first rotational body 14 and the second rotational body 18. In an example in which the at least one transmission stage includes more than one transmission stage, a different transmission ratio is set to each transmission stage. For example, the transmission ratio becomes greater as the transmission stage increases.

In a case where the first rotational body 14 includes more than one first sprocket, and the second rotational body 18 includes more than one second sprocket, the transmission stage is set in accordance with, for example, a combination of one of the first sprockets and one of the second sprockets. In a case where the first rotational body 14 includes one first sprocket, and the second rotational body 18 includes more than one second sprocket, the transmission stage is set in accordance with, for example, a combination of the one first sprocket and one of the second sprockets. In a case where the first rotational body 14 includes more than one first sprocket, and the second rotational body 18 includes one second sprocket, the transmission stage is set in accordance with, for example, a combination of one of the first sprockets and the one second sprocket.

The derailleur 44A moves, for example, the chain engaged with one of the sprockets to another one of the sprockets. The one of the sprockets having the least teeth corresponds to, for example, the smallest transmission stage obtainable by the derailleur 44A. The one of the sprockets having the most teeth corresponds to, for example, the largest transmission stage obtainable by the derailleur 44A.

In a case where the derailleur 44A includes a front derailleur, the number of first sprockets is, for example, two or greater and three or less. In a case where the derailleur 44A includes a front derailleur, the number of first sprockets is, for example, two.

In a case where the derailleur 44A includes a rear derailleur, the number of second sprockets is, for example, two or greater and twenty or less. In a case where the derailleur 44A includes a rear derailleur, the number of second sprockets is, for example, twelve.

The human-powered vehicle 10 further includes, for example, a shifting device 44B configured to operate the transmission device 44. The shifting device 44B is, for example, provided on the handlebar 38. The shifting device 44B can be connected to the transmission device 44 by a Bowden cable or the like. Alternatively, the shifting device 44B can be electrically connected to the transmission device 44 in a manner allowing for communication. In a case where the shifting device 44B is electrically connected to the transmission device 44 in a manner allowing for communication, the transmission device 44 can include, for example, an electric actuator.

The first operating unit 24 is configured to be operable by a user of the human-powered vehicle 10 and irrelevant to a shifting operation of the human-powered vehicle 10. The transmission device 44 is, for example, configured not to be actuated in accordance with operation of the first operating unit 24. For example, the first operating unit 24 differs from the shifting device 44B. The first operating unit 24 is, for example, provided on the human-powered vehicle 10 separately from the shifting device 44B. The first operating unit 24 and the shifting device 44B are, for example, configured so that the user can separately operate the first operating unit 24 and the shifting device 44B.

The first operating unit 24 is, for example, provided on the human-powered vehicle 10 at a portion that is easily operated by the user traveling on the human-powered vehicle 10. The first operating unit 24 is, for example, provided on the handlebar 38. In a case where the user operates the first operating unit 24, the first operating unit 24 transmits an operation signal to the electronic controller 72 in order to drive the motor 22. The first operating unit 24 includes, for example, at least one of a switch, a lever, and a dial.

The motor 22 is configured to drive the transmission body 20. The motor 22 is, for example, configured to apply a propulsion force to the human-powered vehicle 10 in accordance with the human driving force. The motor 22 includes, for example, one or more electric motors. The electric motor of the motor 22 is, for example, a brushless motor. The motor 22 is, for example, configured to transmit a rotational force to a power transmission path of the human driving force extending from the pedals 32A and 32B to the second rotational body 18.

In the present embodiment, the motor 22 is, for example, configured to drive the transmission body 20 via the first rotational body 14. The motor 22 is, for example, provided on the frame 28 and configured to transmit a rotational force to the first rotational body 14. The motor 22 can have any configuration as long as the motor 22 is capable of driving the transmission body 20. The motor 22 can be configured to drive the transmission body 20 via the second rotational body 18. The motor 22 can be provided in the hub of the human-powered vehicle 10 and configured to transmit rotational force to the second rotational body 18.

The human-powered vehicle 10 further includes a housing 48 in which the motor 22 is provided. The motor 22 and the housing 48 form a drive unit 50. The housing 48 is attached to the frame 28. The crank axle 12 is rotatably supported by the housing 48. The motor 22 can be configured to transmit a rotational force to the transmission body 20 without using the first rotational body 14. In an example in which the motor 22 is configured to transmit rotational force to the transmission body 20 without using the first rotational body 14, a sprocket that engages the transmission body 20 is provided on an output shaft 22A of the motor 22 or a transmission member to which the force from the output shaft 22A of the motor 22 is transmitted.

The drive unit 50 further includes, for example, an output unit 52. The output unit 52 is, for example, arranged coaxially with the crank axle 12. The output unit 52 is, for example, configured to receive a human driving force and an output of the motor 22. The output unit 52 is, for example, configured to receive the rotational force of the crank axle 12 and the output of the motor 22. The output unit 52 is, for example, cylindrical. The output unit 52 is, for example, provided on an outer circumferential portion of the crank axle 12 about a rotational axis C1 of the crank axle 12. The first rotational body 14 is, for example, coupled to a first end 52A of the output unit 52 in a manner rotatable integrally with the output unit 52.

The drive unit 50 includes, for example, a speed reducer 54. The speed reducer 54 is, for example, provided between the motor 22 and the power transmission path of the human driving force. The speed reducer 54 includes, for example, at least one speed reducing unit. The at least one speed reducing unit includes, for example, a first speed reducing unit 54A, a second speed reducing unit 54B, and a third speed reducing unit 54C. The number of speed reducing units included in the speed reducer 54 can be one, two, four or more.

The first speed reducing unit 54A receives, for example, rotational torque of the motor 22. The first speed reducing unit 54A includes, for example, two gears meshed with each other. The first speed reducing unit 54A can include a belt and pulleys instead of the gears. The first speed reducing unit 54A can include sprockets and a chain instead of the gears.

The second speed reducing unit 54B receives, for example, the rotational torque of the motor 22 via the first speed reducing unit 54A. The second speed reducing unit 54B includes, for example, two gears meshed with each other. The second speed reducing unit 54B can include a belt and pulleys instead of the gears. The second speed reducing unit 54B can include sprockets and a chain instead of the gears.

The third speed reducing unit 54C receives, for example, the rotational torque of the motor 22 via the second speed reducing unit 54B. The third speed reducing unit 54C transmits the rotational torque of the motor 22 to, for example, the output unit 52. The third speed reducing unit 54C includes, for example, two gears meshed with each other. The third speed reducing unit 54C can include a belt and pulleys instead of the gears. The third speed reducing unit 54C can include sprockets and a chain instead of the gears.

The drive unit 50 further includes, for example, a second one-way clutch 56. The second one-way clutch 56 is provided in a power transmission path from the crank axle 12 to the first rotational body 14. The second one-way clutch 56 is, for example, provided between the crank axle 12 and the output unit 52.

The second one-way clutch 56 is, for example, configured to rotate the first rotational body 14 forward in a case where the crank axle 12 is rotated forward. The second one-way clutch 56 is, for example, further configured to allow relative rotation of the crank axle 12 and the first rotational body 14 in a case where the crank axle 12 is rotated rearward. The second one-way clutch 56 includes, for example, at least one of a roller clutch, a sprag clutch, and a ratchet clutch.

The drive unit 50 further includes, for example, a third one-way clutch 58. The third one-way clutch 58 is, for example, provided in a power transmission path extending from the motor 22 to the first rotational body 14. The third one-way clutch 58 is, for example, provided on the speed reducer 54.

The third one-way clutch 58 is, for example, configured to transmit the rotational force of the motor 22 to the output unit 52. The third one-way clutch 58 is, for example, configured to restrict transmission of the rotational force of the crank axle 12 to the motor 22 in a case where the crank axle 12 is rotated forward. The third one-way clutch 58 includes, for example, at least one of a roller clutch, a sprag clutch, and a ratchet clutch.

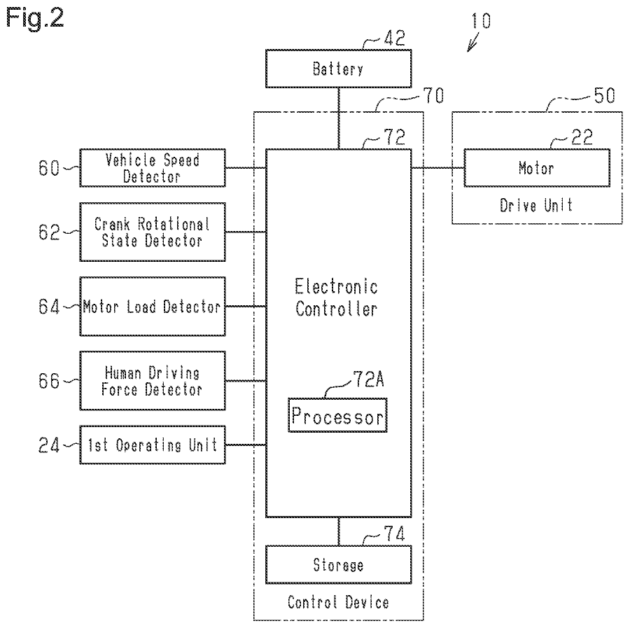

As seen in FIG. 2, the human-powered vehicle 10 further includes one or more detectors for detecting an operating condition of the human-powered vehicle 10. The term “detector” as used herein refers to a hardware device or instrument designed to detect the presence or absence of a particular event, object, substance, or a change in its environment, and to emit a signal in response. The term “detector” as used herein do not include a human being.

As seen in FIG. 2, the human-powered vehicle 10 further includes the electronic controller 72, mentioned above. The electronic controller 72 is configured to control the motor 22. The electronic controller 72 is configured to receive input signals from the detectors. In this way, the electronic controller 72 can control the motor 22 based on a human-powered vehicle condition (e.g., a traveling state of the human-powered vehicle or an operating state of a component of the human-powered vehicle) detected by one or more of the detectors.

The human-powered vehicle 10 further includes, for example, a vehicle speed detector 60. The vehicle speed detector 60 is, for example, connected to the electronic controller 72 in a manner allowing for wired communication or wireless communication. The vehicle speed detector 60 is, for example, configured to detect information related to speed of the human-powered vehicle 10. The vehicle speed detector 60 is, for example, configured to detect information related to the rotational speed of the wheel 16. The vehicle speed detector 60 is, for example, configured to detect a magnet provided on at least one of the front wheel 16F and the rear wheel 16R.

The vehicle speed detector 60 is, for example, configured to output a predetermined number of detection signals during a period in which the wheel 16 completes one rotation. The predetermined number is, for example, one. The vehicle speed detector 60 outputs, for example, a signal corresponding to the rotational speed of the wheel 16. The electronic controller 72 can calculate the speed of the human-powered vehicle 10 based on the signal corresponding to the rotational speed of the wheel 16 and information related to the circumferential length of the wheel 16. The information related to the circumferential length of the wheel 16 is, for example, stored in storage 74.

The human-powered vehicle 10 further includes, for example, a crank rotational state detector 62. The crank rotational state detector 62 is, for example, connected to the electronic controller 72 in a manner allowing for wired communication or wireless communication. The crank rotational state detector 62 detects, for example, a rotational amount of at least one of the crank axle 12 and the first rotational body 14.

The crank rotational state detector 62 is, for example, configured to detect information corresponding to at least one of the rotational speed of the crank axle 12 and a rotational speed of the first rotational body 14. The information corresponding to the rotational speed of the crank axle 12 includes, for example, an angular acceleration of the crank axle 12. The information corresponding to the rotational speed of the first rotational body 14 includes, for example, an angular acceleration of the first rotational body 14.

The crank rotational state detector 62 is, for example, configured to output a signal corresponding to at least one of the rotational speed of the crank axle 12 and the rotational speed of the first rotational body 14. The crank rotational state detector 62 is, for example, configured to output a detection signal corresponding to a rotational angle of at least one of the crank axle 12 and the first rotational body 14 during a period in which at least one of the crank axle 12 and the first rotational body 14 completes one rotation.

The crank rotational state detector 62 includes, for example, a magnetic sensor that outputs a signal corresponding to the strength of a magnetic field. The crank rotational state detector 62 includes, for example, a ring-shaped magnet having magnetic poles arranged in a circumferential direction. The ring-shaped magnet is, for example, provided on the crank axle 12, the first rotational body 14, or the power transmission path between the crank axle 12 and the first rotational body 14. The ring-shaped magnet includes, for example, one S-pole and one N-pole. Each of the S-pole and the N-pole continuously extends over 180° about the rotational axis C1 of the crank axle 12. Instead of the magnetic sensor, the crank rotational state detector 62 can include an optical sensor, an acceleration sensor, a gyro sensor, a torque sensor, or the like.

The crank rotational state detector 62 is, for example, provided on the frame 28. In a case where the crank rotational state detector 62 is provided on the frame 28, the crank rotational state detector 62 can include a vehicle speed sensor. In a case where the crank rotational state detector 62 includes a vehicle speed sensor, the electronic controller 72 can be configured to calculate the rotational speed of the crank axle 12 in accordance with the speed detected by the vehicle speed sensor and the transmission ratio. The crank rotational state detector 62 can be provided on the drive unit 50.

The crank rotational state detector 62 can be configured to detect a rotational amount of the second rotational body 18. The crank rotational state detector 62 can be configured to detect information corresponding to a rotational speed of the second rotational body 18. The information corresponding to the rotational speed of the second rotational body 18 includes, for example, angular acceleration of the second rotational body 18. The crank rotational state detector 62 can be configured to output a signal corresponding to the rotational speed of the second rotational body 18.

The human-powered vehicle 10 further includes, for example, a motor load detector 64 configured to detect a load on the motor 22. The motor load detector 64 is, for example, connected to the electronic controller 72 in a manner allowing for wired communication or wireless communication. The motor load detector 64 is, for example, configured to detect the load on the motor 22. The motor load detector 64 includes, for example, a current sensor that detects the current flowing through the motor 22 and a rotation sensor that detects a rotational speed of the motor 22. The load on the motor 22 can be detected using a known technique based on the current flowing through the motor 22 and the rotational speed of the motor 22. Thus, the load on the motor 22 will not be described in detail. The motor load detector 64 can be included in the motor 22.

The human-powered vehicle 10 further includes, for example, a human driving force detector 66. The human driving force detector 66 is, for example, connected to the electronic controller 72 in a manner allowing for wired communication or wireless communication. The human driving force detector 66 is, for example, configured to output a signal corresponding to a torque applied to the crank axle 12 by a human driving force. The signal corresponding to the torque applied to the crank axle 12 by the human driving force includes information related to the human driving force input to the human-powered vehicle 10.

The human driving force detector 66 is, for example, provided on a member included in the transmission path of the human driving force or a member arranged near the member included in the transmission path of the human driving force. The member included in the transmission path of the human driving force includes, for example, the crank axle 12 and a member that transmits the human driving force between the crank axle 12 and the first rotational body 14. The human driving force detector 66 is, for example, provided on a power transmission portion configured to transmit the human driving force from the crank axle 12 to the output unit 52. The power transmission portion is, for example, provided on the outer circumferential portion of the crank axle 12.

The human driving force detector 66 includes a strain sensor, a magnetostrictive sensor, a pressure sensor, or the like. A strain sensor includes a strain gauge. The human driving force detector 66 can have any configuration as long as information related to a human driving force is obtained.

The human driving force detector 66 can be, for example, provided on at least one of the crank arms 30A and 30B or at least one of the pedals 32A and 32B. In a case where the human driving force detector 66 is provided on at least one of the pedals 32A and 32B, the human driving force detector 66 can include a sensor that detects the pressure applied to the at least one of the pedals 32A and 32B. The human driving force detector 66 can be provided on the chain included in the transmission body 20. In a case where the human driving force detector 66 is provided on the chain, the human driving force detector 66 can include a sensor that detects the tension on the chain.

As mentioned above, the human-powered vehicle control device 70 includes the electronic controller 72. The electronic controller 72 includes, for example, one or more processors 72A that execute predetermined control programs. Each of the processors 72A of the electronic controller 72 includes, for example, a central processing unit (CPU) or a micro-processing unit (MPU).

The processors 72A of the electronic controller 72 can be located at separate positions. Some of the processors 72A can be located on the human-powered vehicle 10, and the other processors 72A can be located in a server connected to the internet. In a case where the processors 72A are located at separate positions, the processors 72A are connected to one another via a wireless communication device in a manner allowing for communication. The electronic controller 72 can include one or more microcomputers. The electronic controller 72 is formed of one or more semiconductor chips that are mounted on a circuit board. Thus, the terms “electronic controller” and “controller” as used herein refers to hardware that executes a software program, and does not include a human being.

The control device 70 further includes, for example, the storage 74. The storage 74 is any computer storage device or any non-transitory computer-readable medium with the sole exception of a transitory, propagating signal. The storage 74 is, for example, connected to the electronic controller 72 in a manner allowing for wired communication or wireless communication. The storage 74 stores, for example, control programs and information used for control processes. The storage 74 includes, for example, a non-volatile memory and a volatile memory. The non-volatile memory includes, for example, at least one of a read-only memory (ROM), an erasable programmable read-only memory (EPROM), an electrically erasable programmable read-only memory (EEPROM), and a flash memory. The volatile memory includes, for example, a random-access memory (RAM).

The control device 70 can further include a drive circuit of the motor 22. The electronic controller 72 and the drive circuit are, for example, provided in the housing 48. The electronic controller 72 and the drive circuit can be provided on the same circuit board. The drive circuit is, for example, connected to the electronic controller 72 in a manner allowing for wired communication or wireless communication. The drive circuit drives the motor 22 in response to, for example, a control signal from the electronic controller 72.

The drive circuit is, for example, electrically connected to the motor 22. The drive circuit controls, for example, supply of electric power from the battery 42 to the motor 22. The drive circuit includes, for example, an inverter circuit. The inverter circuit includes, for example, transistors. The inverter circuit has, for example, a configuration in which inverter units are connected to one another in parallel. Each inverter unit is formed by two transistors connected in series. The inverter circuit can include a current sensor that detects the current flowing through the inverter circuit. The current sensor is, for example, connected to the electronic controller 72 in a manner allowing for wired communication or wireless communication.

The electronic controller 72 is, for example, configured to control the motor 22. The electronic controller 72 is, for example, configured to control the motor 22 in accordance with a state of the human-powered vehicle 10. The electronic controller 72 is, for example, configured to control the motor 22 so that the output of the motor 22 changes in accordance with the human driving force input to the human-powered vehicle 10. The electronic controller 72 is, for example, configured to control the motor 22 so that the propulsion force changes in accordance with the human driving force input to the human-powered vehicle 10. The electronic controller 72 is, for example, configured to control the motor 22 in accordance with the human driving force detected by the human driving force detector 66.

The electronic controller 72 is, for example, configured to control the motor 22 in accordance with at least one of the rotational speed of the crank axle 12 and the rotational speed of the first rotational body 14 detected by the crank rotational state detector 62. The electronic controller 72 is, for example, configured to control the motor 22 in accordance with the speed of the human-powered vehicle 10 detected by the vehicle speed detector 60.

The electronic controller 72 can be configured to drive the motor 22 so as to apply a propulsion force to the human-powered vehicle 10 in accordance with at least one of the human driving force and the rotational speed of the crank axle 12 in a case where the speed of the human-powered vehicle 10 is less than or equal to a first vehicle speed. The predetermined first vehicle speed is, for example, set by regulations. The first vehicle speed is, for example, 25 km/h or 27.5 km/h.

The electronic controller 72 is, for example, configured to control the motor 22 so that an assist level of the motor 22 is a predetermined assist level. The assist level includes, for example, at least one of a ratio of the output of the motor 22 to the human driving force input to the human-powered vehicle 10, the maximum value of the output of the motor 22, and a restriction level that restricts changes in the output of the motor 22 in a case where the output of the motor 22 decreases.

The electronic controller 72 is, for example, configured to control the motor 22 so that a ratio of assist force to the human driving force is a predetermined ratio. The human driving force corresponds to, for example, the propulsion force of the human-powered vehicle 10 produced by the user rotating the crank axle 12. The human driving force corresponds to, for example, the driving force input to the first rotational body 14 by the user rotating the crank axle 12.

The assist force includes, for example, the driving force input to the first rotational body 14 in accordance with the output of the motor 22. The assist force corresponds to, for example, the propulsion force of the human-powered vehicle 10 produced by rotation of the motor 22. In an example in which the drive unit 50 includes the speed reducer 54, the assist force corresponds to the output of the speed reducer 54.

The predetermined ratio does not have to be set constant and can be varied in accordance with at least one of the human driving force, the rotational speed of the crank axle 12, the rotational speed of the first rotational body 14, and the vehicle speed. The predetermined ratio does not have to be set constant and can be varied in accordance with the vehicle speed and at least one of the human driving force, the rotational speed of the crank axle 12, and the rotational speed of the first rotational body 14.

The human driving force corresponds to, for example, the propulsion force of the human-powered vehicle 10 produced by the user rotating the crank axle 12. The human driving force corresponds to, for example, the driving force input to the first rotational body 14 by the user rotating the crank axle 12. The human driving force is, for example, expressed as at least one of torque and power. In a case where the human driving force is expressed as torque, the human driving force is described as, for example, human torque. The power of the human driving force is, for example, the product of the torque applied to the crank axle 12 and the rotational speed of the crank axle 12.

The assist force is, for example, expressed as at least one of torque and power. In a case where the assist force is expressed as a torque, the assist force is described as, for example, an assist torque. In a case where the assist force is expressed as a power, the assist force is described as, for example, an assist power. The assist power is, for example, the product of the output torque of the speed reducer 54 and the rotational speed of an output shaft of the speed reducer 54. The ratio of the assist force to the human driving force can be a ratio of the assist torque to the human torque or a ratio of the assist power to the human force based power.

The electronic controller 72 is, for example, configured to control the motor 22 so that the assist force is less than or equal to the maximum assist force. The electronic controller 72 is, for example, configured to control the motor 22 so that the assist torque is less than or equal to the maximum assist torque. The maximum assist torque is, for example, a value in a range from 20 Nm or greater and 200 Nm or less. The maximum assist torque is, for example, determined by at least one of an output characteristic and a control mode of the motor 22. The electronic controller 72 can be configured to control the motor 22 so that the assist power is less than or equal to the maximum assist power.

The electronic controller 72 is configured to control the motor 22 so as to drive the transmission body 20 with the motor 22 without propelling the human-powered vehicle 10 with the driving force of the motor 22 upon the user operating the first operating unit 24.

The electronic controller 72 is, for example, configured to control the motor 22 so as to drive the transmission body 20 with the motor 22 without propelling the human-powered vehicle 10 with the driving force of the motor 22 in a case where the user operates the first operating unit 24. The electronic controller 72 is, for example, configured to control the motor 22 so as to drive the transmission body 20 with the motor 22 without propelling the human-powered vehicle 10 with the driving force of the motor 22 in a case where the electronic controller 72 receives an operation signal from the first operating unit 24.

The electronic controller 72 can be configured to control the motor 22 so as to drive the transmission body 20 with the motor 22 without rotating the wheel 16 with the driving force of the motor 22 in a case where the user operates the first operating unit 24. The electronic controller 72 can be configured to control the motor 22 so as to drive the transmission body 20 with the motor 22 in a manner allowing for shifting by the derailleur 44A without rotating the wheel 16 with the driving force of the motor 22 in a case where the user operates the first operating unit 24.

The electronic controller 72 is, for example, configured to stop the motor 22 in a case where the user stops operating the first operating unit 24. In an example in which the user starts operating the first operating unit 24 and continues to operate the first operating unit 24, the electronic controller 72 is configured to stop the motor 22 upon the user stopping the operation of the first operating unit 24.

In an example in which the user operates the first operating unit 24 and drives the motor 22, the electronic controller 72 is configured to stop the motor 22 upon a stopping condition of the motor being satisfied. The stopping condition includes, for example, at least one of a first stopping condition in which a predetermined period elapses from when driving of the motor 22 is started and a second stopping condition in which a load on the motor 22 is greater than or equal to a first threshold value.

The first threshold value is, for example, a value allowing for determination that a foreign object or the like has been caught in at least one of the transmission body 20, the first rotational body 14, and the second rotational body 18. The first threshold value can be a value allowing for determination that the transmission body 20 is tensioned. The predetermined period includes at least one of a predetermined time, a period during which the output shaft 22A of the motor 22 is rotated more than a first rotational angle, and a period during which the first rotational body 14 is rotated by the motor 22 more than a second rotational angle. The predetermined period is, for example, set to a period necessary for checking actuation of at least one of the motor 22, the transmission body 20, the first rotational body 14, and the second rotational body 18. The period necessary for checking actuation of at least one of the motor 22, the transmission body 20, the first rotational body 14, and the second rotational body 18 is, for example, set based on the resolution of a sensor that detects actuation of at least one of the motor 22, the transmission body 20, the first rotational body 14, and the second rotational body 18. The predetermined time is, for example, one second or longer and ten seconds or shorter. The first rotational angle is, for example, 180 degrees or greater and 720 degrees or less. The second rotational angle is, for example, 90 degrees or greater and 360 degrees or less. The predetermined period can be set by the user.

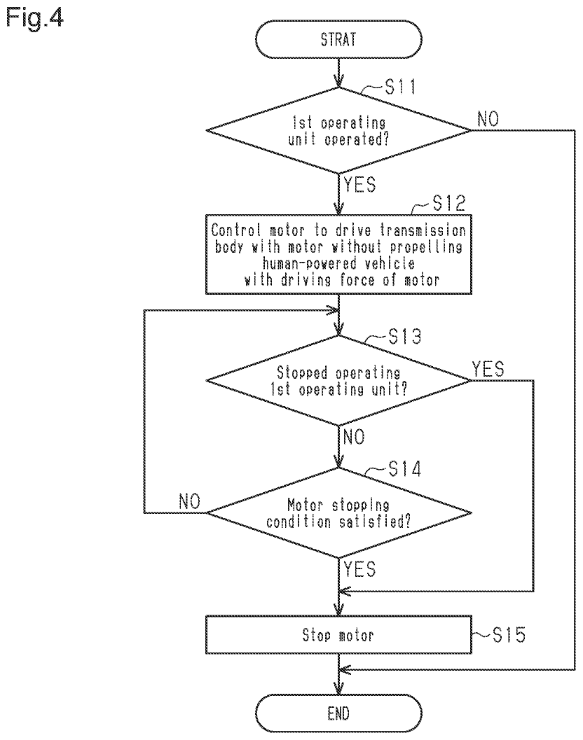

A process executed by the electronic controller 72 to control the motor 22 will now be described with reference to FIG. 4. In an example in which electric power is supplied to the electronic controller 72, the electronic controller 72 starts the process of the flowchart shown in FIG. 4 from step S11. In a case where the process of the flowchart shown in FIG. 4 ends, the electronic controller 72 repeats the process from step S11 in predetermined cycles until, for example, the supply of electric power stops.

In step S11, the electronic controller 72 determines whether the first operating unit 24 is operated. In a case where the first operating unit 24 has been operated, the electronic controller 72 proceeds to step S12. In a case where the first operating unit 24 is not operated, the electronic controller 72 ends processing. In step 12, the electronic controller 72 controls the motor 22 to drive the transmission body 20 with the motor 22 without propelling the human-powered vehicle 10 with the driving force of the motor 22. Then, the electronic controller 72 proceeds to step S13.

In step S13, the electronic controller 72 determines whether the operation of the first operating unit 24 is stopped. In a case where the operation of the first operating unit 24 is not stopped, the electronic controller 72 proceeds to step S14. The electronic controller 72 determines that the operation of the first operating unit 24 is not stopped in an example in which the electronic controller 72 continues to receive an operation signal from the first operating unit 24. In a case where the operation of the first operating unit 24 has been stopped, the electronic controller 72 proceeds to step S15.

In step S14, the electronic controller 72 determines whether the stopping condition of the motor 22 is satisfied. In a case where the stopping condition of the motor 22 is satisfied, the electronic controller 72 proceeds to step S15. The electronic controller 72 determines that the stopping condition of the motor 22 is satisfied in an example in which at least one of the first stopping condition, in which the predetermined period elapses from when driving of the motor 22 is started, and the second stopping condition, in which the load on the motor 22 is greater than or equal to the first threshold value, is satisfied. In a case where the stopping condition of the motor 22 is not satisfied, the electronic controller 72 proceeds to step S13 and repeats the process from step S13. In step S15, the electronic controller 72 stops the motor 22 and then ends processing.

The electronic controller 72 can be configured to drive the motor 22 in a manner allowing for propulsion of the human-powered vehicle 10 with the motor 22 in a case where the human driving force becomes greater than a first driving force during the process shown in FIG. 4. The first driving force includes, for example, a pedaling driving force produced by a rider. The first driving force is, for example, greater than zero.

Step S13 can be omitted from the process shown in FIG. 4. In a case where step S13 is omitted, the electronic controller 72 proceeds to step S14 after step S12. Step S14 can be omitted from the process shown in FIG. 4. In a case where step S14 is omitted, the electronic controller 72 proceeds to step S15 upon an affirmative determination being given in step S13. In a case where step S14 is omitted, the electronic controller 72 repeats the process from step S13 upon a negative determination being given in step S13. Steps S13 to S15 can be omitted from the process shown in FIG. 4. In a case where steps S13 to S15 are omitted, the electronic controller 72 ends processing after step S12.

The user can operate the first operating unit 24 in order to, for example, check actuation of the transmission body 20, adjust the transmission device 44, increase the tension on the transmission body 20, firmly engage the transmission body 20 and the second rotational body 18, restrict reverse rotation of the transmission body 20, or firmly engage the transmission body 20 and the first rotational body 14. In an example in which the first operating unit 24 is operated, the electronic controller 72 drives the transmission body 20 with the motor 22 without propelling the human-powered vehicle 10 with the driving force of the motor 22. This allows the user to, for example, check actuation of the transmission body 20 in a preferred manner.

### Second Embodiment

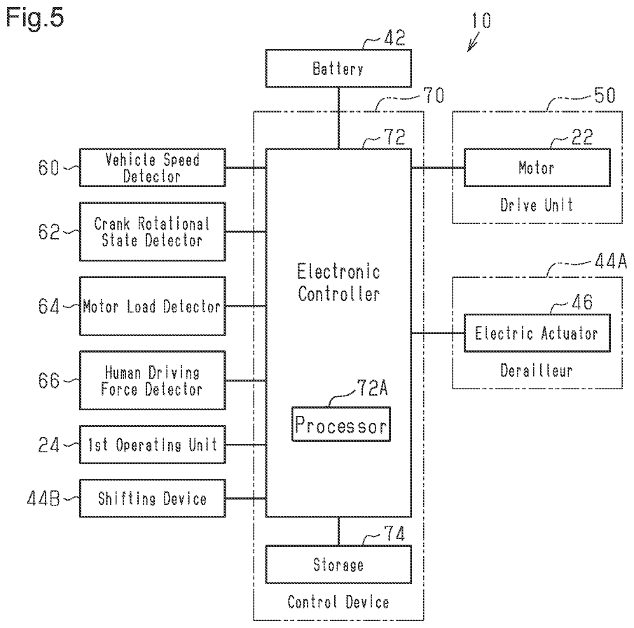

A human-powered vehicle control device 70 in accordance with a second embodiment will now be described with reference to FIGS. 5 to 7. Same reference numerals are given to those components of the human-powered vehicle control device 70 in the second embodiment that are the same as the corresponding components in the first embodiment. Such components will not be described in detail.

In the present embodiment, the human-powered vehicle 10 includes the transmission device 44. In the present embodiment, the transmission device 44 includes the derailleur 44A. The transmission device 44 of the present embodiment includes an electric actuator 46. The electric actuator 46 is, for example, configured to actuate the derailleur 44A. The electronic controller 72 of the present embodiment is, for example, configured to control the derailleur 44A.

In the present embodiment, the electronic controller 72 is configured to drive the transmission body 20 with the motor 22 without propelling the human-powered vehicle 10 with the driving force of the motor 22 upon a user operating the first operating unit 24 in a case where a first condition is satisfied.

The electronic controller 72 is, for example, configured to control the motor 22 so as to drive the transmission body 20 with the motor 22 without propelling the human-powered vehicle 10 with the driving force of the motor 22 as the user operates the first operating unit 24 in a case where the first condition is satisfied. The electronic controller 72 is, for example, configured to control the motor 22 so as to drive the transmission body 20 with the motor 22 without propelling the human-powered vehicle 10 with the driving force of the motor 22 as the electronic controller 72 receives an operation signal from the first operating unit 24 in a case where the first condition is satisfied.

The electronic controller 72 can be configured to control the motor 22 so as to drive the transmission body 20 with the motor 22 without rotating the wheel 16 with the driving force of the motor 22 as the user operates the first operating unit 24 in a case where the first condition is satisfied. The electronic controller 72 can be configured to control the motor 22 so as to drive the transmission body 20 with the motor 22 in a manner allowing for shifting by the derailleur 44A without rotating the wheel 16 with the driving force of the motor 22 as the user operates the first operating unit 24 in a case where the first condition is satisfied.

The first condition includes a condition in which rotation of the crank axle 12 is stopped. The first condition is, for example, a condition allowing for determination that the rider stops pedaling. A state in which rotation of the crank axle 12 is stopped includes, for example, a state in which the rotational speed of the crank axle 12 is less than or equal to a predetermined rotational speed.

The electronic controller 72 is, for example, configured to determine that rotation of the crank axle 12 is stopped in a case where the rotational speed of the crank axle 12 is less than or equal to the predetermined rotational speed. The electronic controller 72 determines that the first condition is satisfied in an example in which the rotational speed of the crank axle 12 is less than or equal to the predetermined rotational speed. The predetermined rotational speed is, for example, 0 rpm or greater and 5 rpm or less. The predetermined rotational speed is, for example, 3 rpm. The predetermined rotational speed can be greater than 0 rpm. The predetermined rotational speed can be set based on the rotational speed at which the crank axle 12 rotates back and forth in a case where the rider stops pedaling. The electronic controller 72 can be configured to determine that rotation of the crank axle 12 is stopped in a case where the human driving force is less than or equal to a crank axle stopping determination driving force. The crank axle stopping determination driving force corresponds to, for example, human torque that is 1 Nm or greater and 5 Nm or less.

The electronic controller 72 is configured to drive the transmission body 20 with the motor 22 to propel the human-powered vehicle 10 with the driving force of the motor 22 upon the user operating the first operating unit 24 in a case where the first condition and a second condition are satisfied.

The second condition includes a condition in which speed of the human-powered vehicle 10 is less than a predetermined speed. The second condition is, for example, satisfied in a case where the rider walks the human-powered vehicle 10. The electronic controller 72 is, for example, configured to determine that the second condition is satisfied in a case where the speed of the human-powered vehicle 10 is less than the predetermined speed. The predetermined speed is, for example, 10 km/h or less and 3 km/h or greater. The predetermined speed is, for example, 6 km/h.

The human-powered vehicle 10 can be configured to drive the transmission body 20 with the motor 22 to propel the human-powered vehicle 10 with the driving force of the motor 22 upon the user operating an operating unit, differing from the first operating unit 24 and configured to be operable by the user, in a case where the first condition and the second condition are satisfied. The operating unit that differs from the first operating unit 24 and is configured to be operable by the user includes, for example, an operating unit for driving the motor 22 to apply a propulsion force to the human-powered vehicle 10 in a case where the user walks the human-powered vehicle 10.

The electronic controller 72 is, for example, configured to drive the transmission body 20 with the motor 22 and operate the transmission body 20 with the derailleur 44A in a case where the first condition and a shifting condition for shifting the transmission ratio with the derailleur 44A are satisfied.

The electronic controller 72 is, for example, configured to control the derailleur 44A in a case where the shifting condition is satisfied. The shifting condition is, for example, related to at least one of a traveling state of the human-powered vehicle 10, a traveling environment of the human-powered vehicle 10, and an operating state of the shifting device 44B of the human-powered vehicle 10. The traveling environment of the human-powered vehicle 10 includes, for example, at least one of gradient and traveling resistance of a road surface. The traveling state of the human-powered vehicle 10 includes, for example, vehicle speed, rotational speed of the crank axle 12, a human driving force, and an inclination angle of the human-powered vehicle 10. The shifting device 44B is, for example, configured to be operable by the user.

The shifting condition is, for example, satisfied in a case where the electronic controller 72 receives a shifting instruction from the shifting device 44B. The shifting condition can be a condition related to automatic shifting and satisfied, for example, in at least one of a case where the traveling state of the human-powered vehicle 10 satisfies a predetermined state and a case where the traveling environment of the human-powered vehicle 10 satisfies a predetermined state. The shifting instruction includes, for example, a shifting instruction for increasing the transmission ratio and a shifting instruction for decreasing the transmission ratio.

The electronic controller 72 is, for example, configured to drive the transmission body 20 with the motor 22 and operate the transmission body 20 with the derailleur 44A in a case where the first condition and the shifting condition are satisfied regardless of whether the user operates the first operating unit 24.

The electronic controller 72 is, for example, configured to drive the transmission body 20 with the motor 22 and operate the transmission body 20 with the derailleur 44A in a case where the shifting condition is satisfied in a state in which the rider is riding the traveling human-powered vehicle 10 and rotation of the crank axle 12 is stopped. A case where the shifting condition is satisfied in a state in which the rider is riding the traveling human-powered vehicle 10 and rotation of the crank axle 12 is stopped includes, for example, a case where the shifting device 44B is operated in a state in which pedaling by the rider is stopped.

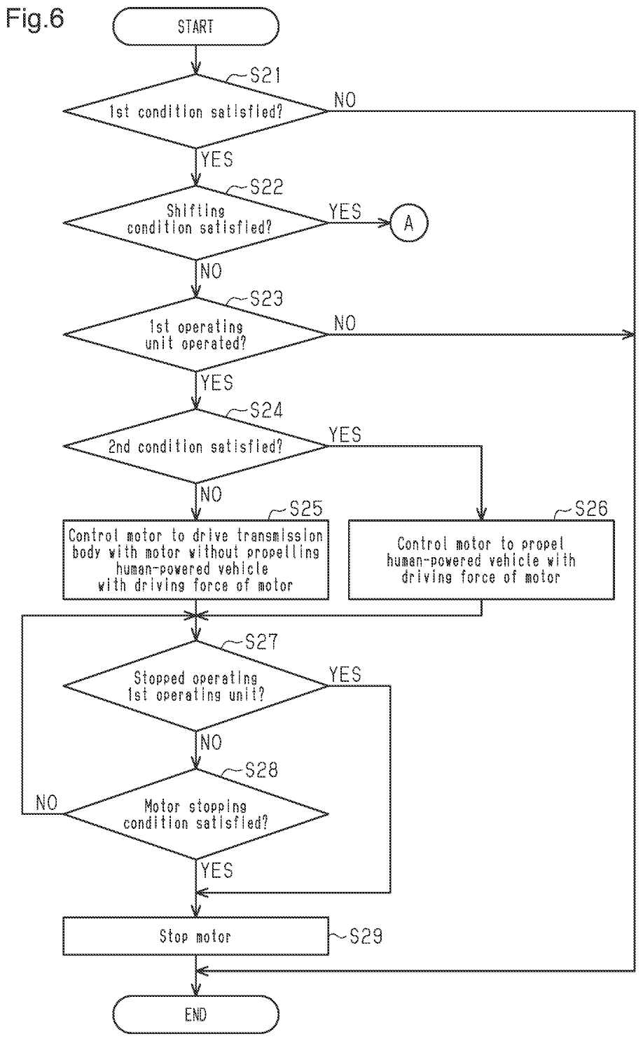

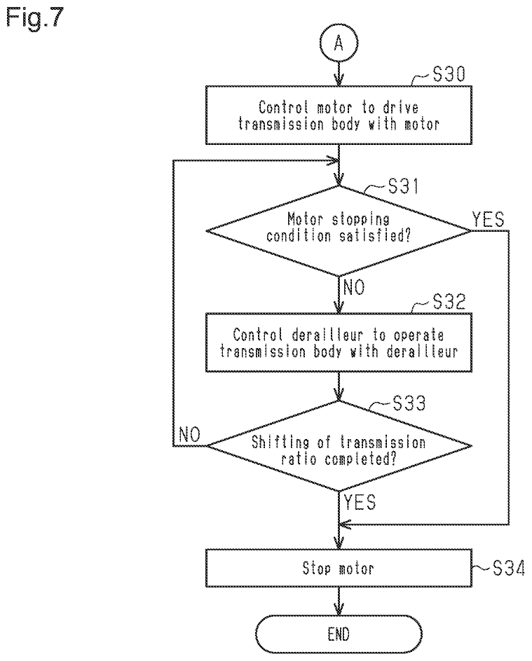

A process executed by the electronic controller 72 of the second embodiment to control the motor 22 will now be described with reference to FIGS. 6 and 7. In an example in which electric power is supplied to the electronic controller 72, the electronic controller 72 starts the process of the flowchart shown in FIG. 6 from step S21. In a case where the process of the flowchart shown in FIG. 6 ends, the electronic controller 72 repeats the process from step S21 in predetermined cycles until, for example, the supply of electric power stops.

In step S21, the electronic controller 72 determines whether the first condition is satisfied. The electronic controller 72 determines that the first condition is satisfied in an example in which rotation of the crank axle 12 is stopped. In a case where the first condition is satisfied, the electronic controller 72 proceeds to step S22. In a case where the first condition is not satisfied, the electronic controller 72 ends processing.

In step S22, the electronic controller 72 determines whether the shifting condition is satisfied. In a case where the shifting condition is not satisfied, the electronic controller 72 proceeds to step S23. In step S23, the electronic controller 72 determines whether the first operating unit 24 is operated. In a case where the first operating unit 24 has been operated, the electronic controller 72 proceeds to step S24. In a case where the first operating unit 24 is not operated, the electronic controller 72 ends processing.

In step S24, the electronic controller 72 determines whether the second condition is satisfied. The electronic controller 72 determines that the second condition is satisfied in an example in which the speed of the human-powered vehicle 10 is less than the predetermined speed. In a case where the second condition is not satisfied, the electronic controller 72 proceeds to step S25. In a case where the second condition is satisfied, the electronic controller 72 proceeds to step S26. In step 25, the electronic controller 72 controls the motor 22 to drive the transmission body 20 with the motor 22 without propelling the human-powered vehicle 10 with the driving force of the motor 22. Then, the electronic controller 72 proceeds to step S27. In step S26, the electronic controller 72 controls the motor 22 to propel the human-powered vehicle 10 with the driving force of the motor 22. Then, the electronic controller 72 proceeds to step S27.

In step S27, the electronic controller 72 determines whether the operation of the first operating unit 24 is stopped. In a case where the operation of the first operating unit 24 is not stopped, the electronic controller 72 proceeds to step S28. The electronic controller 72 determines that the operation of the first operating unit 24 is not stopped in an example in which the electronic controller 72 continues to receive an operation signal from the first operating unit 24. In a case where the operation of the first operating unit 24 has been stopped, the electronic controller 72 proceeds to step S29.

In step S28, the electronic controller 72 determines whether the stopping condition of the motor 22 is satisfied. In a case where the stopping condition of the motor 22 is satisfied, the electronic controller 72 proceeds to step S29. In a case where the stopping condition of the motor 22 is not satisfied, the electronic controller 72 proceeds to step S27 and repeats the process from step S27. In step S29, the electronic controller 72 stops the motor 22 and then ends processing.

In a case where the shifting condition is satisfied in step 22, the electronic controller 72 proceeds to step S30. In step S30, the electronic controller 72 controls the motor 22 so as to drive the transmission body 20 with the motor 22 and then proceeds to step S31.

In step S31, the electronic controller 72 determines whether the stopping condition of the motor 22 is satisfied. In a case where the stopping condition of the motor 22 is not satisfied, the electronic controller 72 proceeds to step S32. In step S32, the electronic controller 72 controls the derailleur 44A so as to operate the transmission body 20 with the derailleur 44A and then proceeds to step S33.

In step S33, the electronic controller 72 determines whether shifting of the transmission ratio is completed. In a case where shifting of the transmission ratio has been completed, the electronic controller 72 proceeds to step S34. In a case where shifting of the transmission ratio is not completed, the electronic controller 72 proceeds to step S31 and repeats the process from step S31. In step S34, the electronic controller 72 stops the motor 22 and then ends processing.

The electronic controller 72 determines that shifting of the transmission ratio is completed in step S33 in an example in which a predetermined shifting period elapses from when shifting of the transmission ratio is started. Step S33 can be omitted. In a case where step S33 is omitted, the electronic controller 72 proceeds to step S34 after step S32.

In a case where the stopping condition of the motor 22 has been satisfied in step S31, the electronic controller 72 proceeds to step S34. The electronic controller 72 determines that the stopping condition of the motor 22 is satisfied in an example in which at least one of the first stopping condition, in which the predetermined period elapses from when driving of the motor 22 is started, and the second stopping condition, in which the load on the motor 22 is greater than or equal to the first threshold value, is satisfied.

Step S27 can be omitted from the process shown in FIG. 6. In a case where step S27 is omitted, the electronic controller 72 proceeds to step S28 after step S25. Step S28 can be omitted from the process shown in FIG. 6. In a case where step S28 is omitted, the electronic controller 72 proceeds to step S29 upon an affirmative determination being given in step S27. In a case where step S28 is omitted, the electronic controller 72 repeats the process of step S27 upon a negative determination being given in step S27. Steps S27 to S29 can be omitted from the process shown in FIG. 6. In a case where steps S27 to S29 are omitted, the electronic controller 72 ends processing after steps S25 and S26.

### Third Embodiment

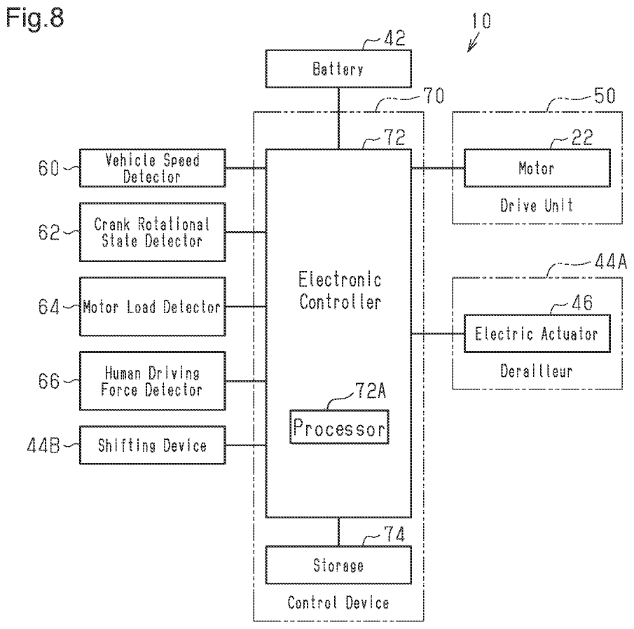

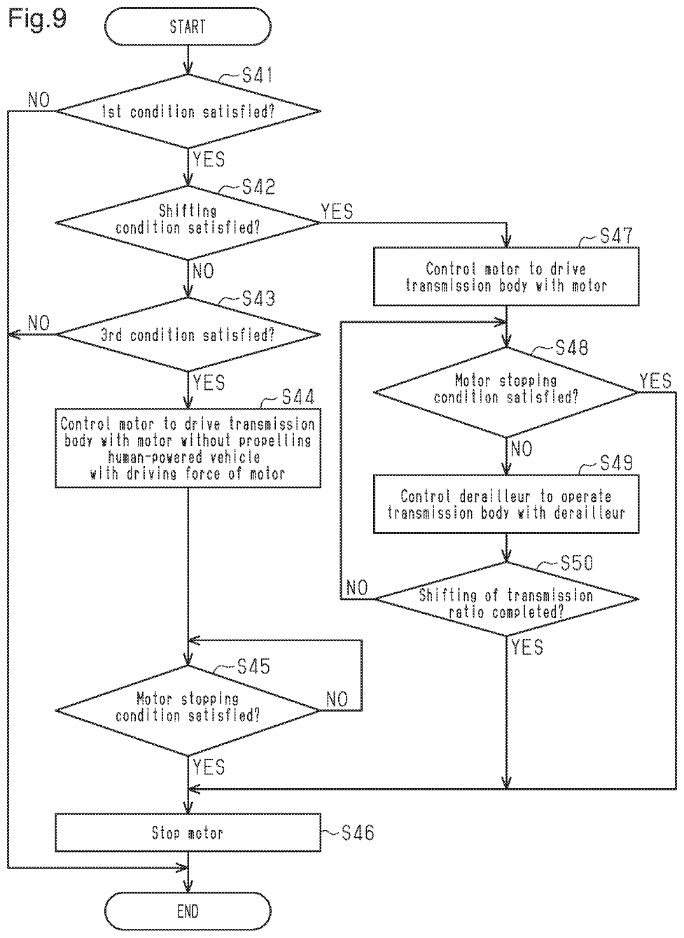

A human-powered vehicle control device 70 in accordance with a third embodiment will now be described with reference to FIGS. 8 and 9. Same reference numerals are given to those components of the human-powered vehicle control device 70 in the third embodiment that are the same as the corresponding components in the first and second embodiments. Such components will not be described in detail.

As shown in FIG. 8, the human-powered vehicle 10 includes the crank axle 12, the first rotational body 14, the wheel 16, the second rotational body 18, the transmission body 20, and the motor 22. The human-powered vehicle 10 of the present embodiment has, for example, a configuration in which the first operating unit 24 is omitted from the human-powered vehicle 10 of the second embodiment.

The human-powered vehicle 10 further includes, for example, an inclination detector. The inclination detector is, for example, configured to detect gradient of the road surface on which the human-powered vehicle 10 travels. The inclination detector detects, for example, a pitch angle of the human-powered vehicle 10. The inclination detector detects, for example, the pitch angle of the human-powered vehicle 10 as the gradient of the road surface on which the human-powered vehicle 10 travels. The gradient of the road surface on which the human-powered vehicle 10 travels can be obtained from, for example, the pitch angle of the human-powered vehicle 10 in a moving direction of the human-powered vehicle 10.

The gradient of the road surface on which the human-powered vehicle 10 travels corresponds to, for example, inclination angle of the human-powered vehicle 10. The inclination detector includes, for example, a gyro sensor or an acceleration sensor. The inclination detector can include a global positioning system (GPS) receiver. The electronic controller 72 can calculate the gradient of the road surface on which the human-powered vehicle 10 travels from GPS information obtained by the GPS receiver and map information that is stored in advance in the storage 74. The inclination detector is, for example, connected to the electronic controller 72 in a manner allowing for wired communication or wireless communication.

The human-powered vehicle 10 further includes a load detector. The load detector is, for example, provided on a wheel axle of the wheel 16. The wheel axle of the wheel 16 includes, for example, a hub axle. The wheel axle of the wheel 16 is, for example, provided on the frame 28 in a manner nonrotatable relative to the frame 28. The load detector is provided on the wheel axle of at least one of the front wheel 16F and the rear wheel 16R. In the present embodiment, the load detector is provided on the wheel axle of each of the front wheel 16F and the rear wheel 16R. The load detector is configured to detect a load on the human-powered vehicle 10. The load detector is, for example, configured to detect information related to at least one of a load on the front wheel 16F, a load on the rear wheel 16R, and a ratio of the load on the rear wheel 16R to the load on the front wheel 16F.

The load detector includes, for example, at least one detection element. The at least one detection element includes, for example, at least one of a pressure sensor and a load sensor. The load detector is, for example, connected to the electronic controller 72 in a manner allowing for wired communication or wireless communication.

The electronic controller 72 is configured to control the motor 22 so as to drive the transmission body 20 with the motor 22 without propelling the human-powered vehicle 10 with the driving force of the motor 22 in a case where a third condition is satisfied.

The third condition includes a condition related to at least one of an inclination of the human-powered vehicle 10 and a load on the human-powered vehicle 10. The third condition includes at least one of a condition in which the human-powered vehicle 10 is traveling on a road corresponding to a downhill having a predetermined gradient or greater and a condition in which the pitch angle of the human-powered vehicle 10 is less than or equal to a predetermined angle that is less than zero. A case where the pitch angle of the human-powered vehicle 10 is zero is, for example, a case where the human-powered vehicle 10 is traveling on a level road. A case where the pitch angle of the human-powered vehicle 10 is less than zero is a case where the human-powered vehicle 10 is traveling on a downhill road.

The third condition includes, for example, a condition in which the load on the front wheel 16F is greater than the load on the rear wheel 16R and a condition in which the ratio of the load on the rear wheel 16R to the load on the front wheel 16F is greater than a predetermined ratio. In a case where the third condition includes a condition related to the load on the human-powered vehicle 10, the electronic controller 72 can be configured to detect jumping of the human-powered vehicle 10 and control the motor 22 so as to drive the transmission body 20 with the motor 22 without propelling the human-powered vehicle 10 with the driving force of the motor 22 before the human-powered vehicle 10 lands.

The third condition further includes, for example, a condition in which rotation of the crank axle 12 is stopped. The third condition further includes, for example, a condition in which the derailleur 44A is deactivated. The electronic controller 72 determines that the derailleur 44A is deactivated, for example, in a case where the electric actuator 46 is inactive. The electronic controller 72 determines that the derailleur 44A is deactivated, for example, in a case where the electronic controller 72 is not executing a control that actuates the derailleur 44A. Instead of or in addition to the condition in which the derailleur 44A is deactivated, the third condition can further include a condition in which the shifting condition is not satisfied.

In an example in which the third condition is satisfied and the motor 22 is driven, the electronic controller 72 is configured to stop the motor 22 upon the stopping condition of the motor 22 being satisfied. In a case where the third condition is satisfied and the motor 22 is driven, the electronic controller 72 determines that the stopping condition of the motor 22 is satisfied in an example in which at least one of the first stopping condition, in which the predetermined period elapses from when driving of the motor 22 is started, and the second stopping condition, in which the load on the motor 22 is greater than or equal to the first threshold value, is satisfied. The stopping condition of the motor 22 in the present embodiment is, for example, the same as the stopping condition of the motor 22 in the first embodiment.

The electronic controller 72 is, for example, configured to control the derailleur 44A. The electronic controller 72 is, for example, configured to drive the transmission body 20 with the motor 22 and operate the transmission body 20 with the derailleur 44A in a case where the first condition and the shifting condition for shifting the transmission ratio with the derailleur 44A are satisfied. The first condition of the present embodiment is, for example, the same as the first condition of the first embodiment. The electronic controller 72 is, for example, configured to drive the transmission body 20 with the motor 22 and operate the transmission body 20 with the derailleur 44A in a case where the first condition and the shifting condition for shifting the transmission ratio with the derailleur 44A are satisfied regardless of whether the third condition is satisfied.

A process executed by the electronic controller 72 of the third embodiment to control the motor 22 will now be described with reference to FIG. 9. In an example in which electric power is supplied to the electronic controller 72, the electronic controller 72 starts the process of the flowchart shown in FIG. 9 from step S41. In a case where the process of the flowchart shown in FIG. 9 ends, the electronic controller 72 repeats the process from step S41 in predetermined cycles until, for example, the supply of electric power stops.

In step S41, the electronic controller 72 determines whether the first condition is satisfied. The electronic controller 72 determines that the first condition is satisfied in an example in which rotation of the crank axle 12 is stopped. In a case where the first condition is satisfied, the electronic controller 72 proceeds to step S42. In a case where the first condition is not satisfied, the electronic controller 72 ends processing.

In step S42, the electronic controller 72 determines whether the shifting condition is satisfied. In a case where the shifting condition is not satisfied, the electronic controller 72 proceeds to step S43. In step S43, the electronic controller 72 determines whether the third condition is satisfied. In a case where the third condition is satisfied, the electronic controller 72 proceeds to step S44. In a case where the third condition is not satisfied, the electronic controller 72 ends processing.

In step 44, the electronic controller 72 controls the motor 22 to drive the transmission body 20 with the motor 22 without propelling the human-powered vehicle 10 with the driving force of the motor 22. Then, the electronic controller 72 proceeds to step S45.

In step S45, the electronic controller 72 determines whether the stopping condition of the motor 22 is satisfied. In a case where the stopping condition of the motor 22 is satisfied, the electronic controller 72 proceeds to step S46. In a case where the stopping condition of the motor 22 is not satisfied, the electronic controller 72 repeats the process of step S45. In step S46, the electronic controller 72 stops the motor 22 and then ends processing.

In a case where the shifting condition is satisfied in step 42, the electronic controller 72 proceeds to step S47. In step S47, the electronic controller 72 controls the motor 22 so as to drive the transmission body 20 with the motor 22 and then proceeds to step S48.

In step S48, the electronic controller 72 determines whether the stopping condition of the motor 22 is satisfied. In a case where the stopping condition of the motor 22 is not satisfied, the electronic controller 72 proceeds to step S49. In step S49, the electronic controller 72 controls the derailleur 44A so as to operate the transmission body 20 with the derailleur 44A and then proceeds to step S50. In a case where the stopping condition of the motor 22 is satisfied, the electronic controller 72 proceeds to step S46.

In step S50, the electronic controller 72 determines whether shifting of the transmission ratio is completed. In a case where shifting of the transmission ratio has been completed, the electronic controller 72 proceeds to step S46. In a case where shifting of the transmission ratio is not completed, the electronic controller 72 proceeds to step S48 and repeats the process from step S48.

The electronic controller 72 determines that shifting of the transmission ratio has been completed in step S50 in an example in which the predetermined shifting period elapses from when shifting of the transmission ratio is started. Step S50 can be omitted. In a case where step S50 is omitted, the electronic controller 72 proceeds to step S46 after step S49.

Steps S41, S42, and S47 to S50 can be omitted from the process shown in FIG. 9. In a case where steps S41, S42, and S47 to step S50 are omitted, the electronic controller 72 starts the process from step S43 as electric power is supplied to the electronic controller 72. Steps S45 and S46 can be omitted from the process shown in FIG. 9. In a case where steps S45 and S46 are omitted, the electronic controller 72 ends processing after step S44.

### Modifications

The description related to the above embodiments exemplifies, without any intention to limit, applicable forms of a control device for a human-powered vehicle according to the present disclosure. In addition to the embodiments described above, the human-powered vehicle control device according to the present disclosure is applicable to, for example, modifications of the above embodiments that are described below and combinations of at least two of the modifications that do not contradict each other. In the modifications described hereafter, same reference numerals are given to those components that are the same as the corresponding components of the above embodiments. Such components will not be described in detail.

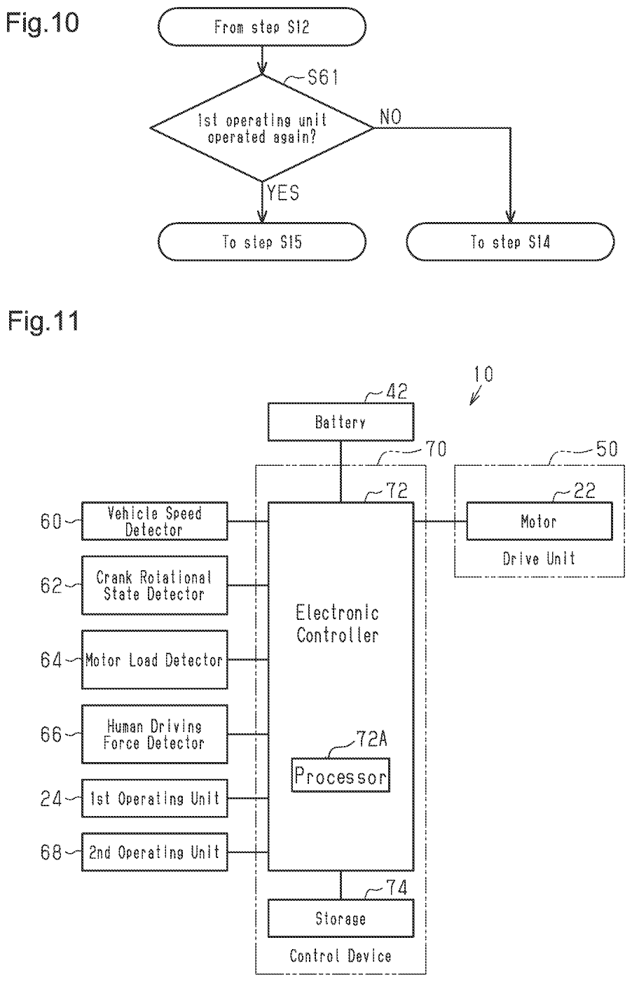

In a case where the user operates the first operating unit 24 to drive the motor 22 and then stops operating the first operating unit 24, the electronic controller 72 can be configured to stop the motor 22 upon the user operating the first operating unit 24 again. A process executed by the electronic controller 72 of a first modification to control the motor 22 will now be described with reference to FIGS. 4 and 10. After step S12, the electronic controller 72 executes step S61 instead of S13. In step S61, the electronic controller 72 determines whether the first operating unit 24 is operated again. In a case where the first operating unit 24 has been operated again, the electronic controller 72 proceeds to step 15. In a case where the first operating unit 24 is not operated again, the electronic controller 72 proceeds to step 14.

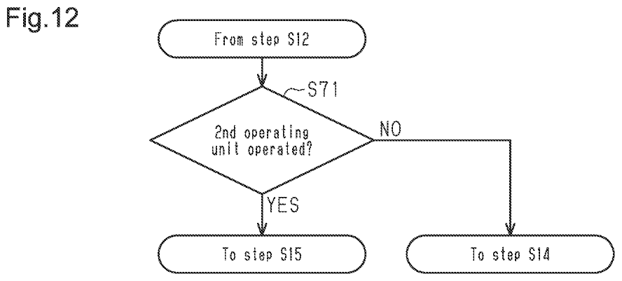

As shown in FIG. 11, the human-powered vehicle 10 can further include a second operating unit 68 that differs from the first operating unit 24 and is configured to be operable by the user. The second operating unit 68 is, for example, provided on the human-powered vehicle 10 at a portion that is easily operated by the user traveling on the human-powered vehicle 10. The second operating unit 68 is, for example, provided on the handlebar 38 at a position separated from the first operating unit 24. In a case where the user operates the second operating unit 68, the second operating unit 68 transmits an operation signal for stopping the motor 22 to the electronic controller 72. The second operating unit 68 includes, for example, at least one of a switch, a lever, and a dial. In a case where the user operates the first operating unit 24 and drives the motor 22, the electronic controller 72 can be configured to stop the motor 22 upon the user operating the second operating unit 68. A process executed by the electronic controller 72 of a second modification to control the motor 22 will now be described with reference to FIGS. 4 and 12. After step S12, the electronic controller 72 executes step S71 instead of S13. In step S71, the electronic controller 72 determines whether the second operating unit 68 is operated. In a case where the second operating unit 68 has been operated, the electronic controller 72 proceeds to step S15. In a case where the second operating unit 68 is not operated, the electronic controller 72 proceeds to step 14.

The electronic controller 72 can be configured not to control the derailleur 44A. In a case where the electronic controller 72 is configured not to control the derailleur 44A, the derailleur 44A can be a manually-operated derailleur that does not include the electric actuator 46. The manually-operated derailleur is, for example, connected to the shifting device 44B by a Bowden cable.

The load detector of the third embodiment can be provided on the saddle 28A. The load detector can be a sheet-like sensor that allows for load detection at positions where the load of the rider is applied to the saddle 28A. In a case where the load detector is provided on the saddle 28A, the at least one detection element is, for example, arranged on the surface of the saddle 28A. The at least one detection element does not have to be arranged on the surface of the saddle 28A as long as information related to distribution of the load applied to the saddle 28A is detected. In an example in which the load detector detects that load is applied to the saddle 28A and the load is applied toward the rear of the saddle 28A, the electronic controller 72 is configured to determine that the human-powered vehicle 10 is traveling downhill. In an example in which the load detector detects that no load is applied to the saddle 28A, the electronic controller 72 determines that the human-powered vehicle 10 is traveling uphill.

Instead of or in addition to the condition related to at least one of the inclination of the human-powered vehicle 10 and the load on the human-powered vehicle 10, the third condition can include a condition related to at least one of a state of a suspension of the human-powered vehicle 10 and vibration information related to vibration of the human-powered vehicle 10. In a case where the third condition includes a condition related to the state of the suspension of the human-powered vehicle 10, the human-powered vehicle 10 includes, for example, a sensor that detects the state of the suspension. The sensor that detects the state of the suspension is, for example, configured to detect at least one of a stroke length and an internal pressure of the suspension. In a case where the third condition includes a condition related to the vibration information, the human-powered vehicle 10 includes, for example, a sensor that detects the vibration information. The sensor that detects the vibration information can be, for example, a sensor that detects the state of the suspension or an acceleration sensor. The suspension absorbs, for example, impacts applied to the wheel 16. The suspension includes, for example, an electric suspension. The suspension includes, for example, at least one of a rear suspension and a front suspension. The suspension can be a coil suspension, a hydraulic suspension, or an air suspension. The state of the suspension includes, for example, a state in which the suspension is actuated. The electronic controller 72 determines that the third condition is satisfied in an example in which at least one of the stroke length and the internal pressure of the suspension is changed. The electronic controller 72 determines that the third condition is satisfied in an example in which the stroke length of the rear suspension decreases and then increases. The electronic controller 72 determines that the third condition is satisfied in an example in which the stroke length of the front suspension decreases and then increases. The third condition can include the condition related to at least one of the state of the suspension and the vibration information related to vibration of the human-powered vehicle 10. In this case, if the third condition is satisfied and the electronic controller 72 drives the motor 22, this will avoid at least one of a situation in which actuation of the suspension loosens the transmission body 20 and causes the transmission body 20 to move violently, a situation in which landing impact actuates the suspension and loosens the transmission body 20, and a situation in which vibration of the human-powered vehicle 10 loosens the transmission body 20.

As long as the human-powered vehicle control device 70 in accordance with the first and second embodiments is configured as described below, any other configuration can be omitted. The human-powered vehicle control device 70 includes the electronic controller 72. The human-powered vehicle 10 includes the crank axle 12, the first rotational body 14, the wheel 16, the second rotational body 18, the transmission body 20, the motor 22, and the first operating unit 24. The crank axle 12 is configured to receive a human driving force. The first rotational body 14 is connected to the crank axle 12. The second rotational body 18 is connected to the wheel 16. The transmission body 20 is engaged with the first rotational body 14 and the second rotational body 18 and configured to transmit the driving force between the first rotational body 14 and the second rotational body 18. The motor 22 is configured to drive the transmission body 20. The first operating unit 24 is configured to be operable by the user of the human-powered vehicle 10 and irrelevant to a shifting operation of the human-powered vehicle 10. The electronic controller 72 is configured to control the motor 22 so as to drive the transmission body 20 with the motor 22 without propelling the human-powered vehicle 10 with the driving force of the motor 22 upon the user operating the first operating unit 24.

As long as the human-powered vehicle control device 70 in accordance with the third embodiment is configured as described below, any other configuration can be omitted. The human-powered vehicle control device 70 includes the electronic controller 72. The human-powered vehicle 10 includes the crank axle 12, the first rotational body 14, the wheel 16, the second rotational body 18, the transmission body 20, and the motor 22. The crank axle 12 is configured to receive a human driving force. The first rotational body 14 is connected to the crank axle 12. The second rotational body 18 is connected to the wheel 16. The transmission body 20 is engaged with the first rotational body 14 and the second rotational body 18 and configured to transmit the driving force between the first rotational body 14 and the second rotational body 18. The motor 22 is configured to drive the transmission body 20. The electronic controller 72 is configured to control the motor 22 so as to drive the transmission body 20 with the motor 22 without propelling the human-powered vehicle 10 with the driving force of the motor 22 in a case where the third condition is satisfied. The third condition includes the condition related to at least one of the inclination of the human-powered vehicle 10 and the load on the human-powered vehicle 10.

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three.

Ordinal numerals such as “first”, “second”, and “third” are used in this disclosure only to distinguish members from one another and are not intended to have a special meaning.

What is claimed is:

1. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, a motor configured to drive the transmission body, and a first operating unit configured to be operable by a user of the human-powered vehicle and irrelevant to a shifting operation of the human-powered vehicle, the control device comprising:
an electronic controller configured to control the motor so as to drive the transmission body with the motor without propelling the human-powered vehicle with the driving force of the motor upon the user operating the first operating unit.

2. The control device according to claim 1, wherein:
the electronic controller is configured to drive the transmission body with the motor without propelling the human-powered vehicle with the driving force of the motor upon the user operating the first operating unit in a case where a first condition is satisfied; and
the first condition includes a condition in which rotation of the crank axle is stopped.

3. The control device according to claim 1, wherein
the electronic controller is configured to stop the motor in a case where the user stops operating the first operating unit.

4. The control device according to claim 1, wherein
in a case where the user operates the first operating unit to drive the motor and then stops operating the first operating unit, the electronic controller is configured to stop the motor upon the user operating the first operating unit again.

5. The control device according to claim 1, wherein:
the human-powered vehicle further includes a second operating unit that differs from the first operating unit, and the second operating unit is configured to be operable by the user; and
in a case where the user operates the first operating unit and drives the motor, the electronic controller is configured to stop the motor upon the user operating the second operating unit.

6. The control device according to claim 1, wherein:
in a case where the user operates the first operating unit and drives the motor, the electronic controller is configured to stop the motor upon a stopping condition of the motor being satisfied; and
the stopping condition includes at least one of a first stopping condition in which a predetermined period elapses from when driving of the motor is started and a second stopping condition in which a load on the motor is greater than or equal to a first threshold value.

7. The control device according to claim 2, wherein:
the electronic controller is configured to drive the transmission body with the motor to propel the human-powered vehicle with the driving force of the motor upon the user operating the first operating unit in a case where the first condition and a second condition are satisfied; and
the second condition includes a condition in which a speed of the human-powered vehicle is less than a predetermined speed.

8. The control device according to claim 2, wherein:
the electronic controller is configured to control a derailleur that is configured to operate the transmission body and shift a transmission ratio of a rotational speed of the wheel to a rotational speed of the crank axle; and
the electronic controller is configured to drive the transmission body with the motor and operate the transmission body with the derailleur in a case where the first condition and a shifting condition for shifting the transmission ratio with the derailleur are satisfied.

9. A control device for a human-powered vehicle including a crank axle configured to receive a human driving force, a first rotational body connected to the crank axle, a wheel, a second rotational body connected to the wheel, a transmission body engaged with the first rotational body and the second rotational body to transmit a driving force between the first rotational body and the second rotational body, and a motor configured to drive the transmission body, the control device comprising:
an electronic controller configured to control the motor so as to drive the transmission body with the motor without propelling the human-powered vehicle with the driving force of the motor in a case where a third condition is satisfied; and
the third condition includes a condition related to at least one of an inclination of the human-powered vehicle and a load on the human-powered vehicle.

10. The control device according to claim 9, wherein
the third condition includes at least one of a condition in which the human-powered vehicle is traveling on a road corresponding to a downhill having a predetermined gradient or greater and a condition in which a pitch angle of the human-powered vehicle is less than or equal to a predetermined angle that is less than zero.

11. The control device according to claim 9, wherein:
in a case where the third condition is satisfied and the motor is driven, the electronic controller is configured to stop the motor upon a stopping condition of the motor being satisfied; and
the stopping condition includes at least one of a first stopping condition in which a predetermined period elapses from when driving of the motor is started and a second stopping condition in which a load on the motor is greater than or equal to a first threshold value.

12. The control device according to claim 9, wherein
the third condition further includes a condition in which rotation of the crank axle is stopped.

13. The control device according to claim 9, wherein:
the human-powered vehicle further includes a derailleur configured to operate the transmission body and shift a transmission ratio of a rotational speed of the wheel to a rotational speed of the crank axle; and
the third condition further includes a condition in which the derailleur is deactivated.

14. The control device according to claim 13, wherein:
the electronic controller is configured to control the derailleur;
the electronic controller is configured to drive the transmission body with the motor and operate the transmission body with the derailleur in a case where a first condition and a shifting condition for shifting the transmission ratio with the derailleur are satisfied; and
the first condition includes a condition in which rotation of the crank axle is stopped.

15. The control device according to claim 6, wherein
the predetermined period includes at least one of a predetermined time, a period during which an output shaft of the motor is rotated more than a first rotational angle, and a period during which the first rotational body is rotated by the motor more than a second rotational angle.

16. The control device according to claim 8, wherein
the shifting condition is related to at least one of a traveling state of the human-powered vehicle, a traveling environment of the human-powered vehicle, and an operating state of a shifting device of the human-powered vehicle.

17. The control device according to claim 11, wherein
the predetermined period includes at least one of a predetermined time, a period during which an output shaft of the motor is rotated more than a first rotational angle, and a period during which the first rotational body is rotated by the motor more than a second rotational angle.

18. The control device according to claim 14, wherein
the shifting condition is related to at least one of a traveling state of the human-powered vehicle, a traveling environment of the human-powered vehicle, and an operating state of a shifting device of the human-powered vehicle.
